(19) United States
(12) Patent Application Publication
(10) Pub. No.: US 2009/0098461 A1
(43) Pub. Date: Apr. 16, 2009

(54) POSITIVE ELECTRODE FOR AN ELECTROCHEMICAL GENERATOR WITH AN ALKALINE ELECTROLYTE

(75) Inventors: Patrick BERNARD, Bordeaux (FR); Lionel Goubault, Carigan de Bordeaux (FR); Olivier Guiader, Bruges (FR)

Correspondence Address: SUGHRUE MION, PLLC, 2100 PENNSYLVANIA AVENUE, N.W., SUITE 800, WASHINGTON, DC, 20037, US

(73) Assignee: SAFT GROUPE SA, Bagnolet (FR)

(21) Appl. No.: 12/245,120

(22) Filed: Oct. 3, 2008

(30) Foreign Application Priority Data
Oct. 5, 2007 (FR) 0706991

(51) Int. Cl. H01M 4/02

(52) U.S. Cl. 429/222; 429/229; 429/231.6; 429/223

(57) ABSTRACT

An electrochemical generator comprising at least one negative electrode and at least one positive electrode, said positive electrode comprising a paste comprising an electrochemically active material, a binder and strontium sulphate SrSO₄, the proportion by weight of strontium sulphate in said paste being greater than 0.1% and less than or equal to 10%.

This generator exhibits a reduced deterioration in performances at a high discharge rate.

### TECHNICAL FIELD

A subject of the invention is an electrochemical generator with an alkaline electrolyte exhibiting a reduced deterioration in performance at a high discharge rate.

### STATE OF THE ART

Non-sintered positive and negative electrodes (also called pasted electrodes) of electrochemical generators with an alkaline electrolyte contain organic compounds such as thickeners, dispersants, elastomers or adhesives which are indispensable for their manufacture. Other carbon-containing compounds are also used, for example for the separator. The latter can be a non-woven fabric made of polypropylene, polyethylene or polyamide sometimes grafted with acrylic functions. Carbon can be used as a negative electrode percolator.

The carbon-containing compounds used in the electrochemical generators with an alkaline electrolyte (in particular those contained in the positive electrode) are capable of oxidizing in contact with the positive electrode. The oxidation reaction of these compounds in a basic solution can be described by the equation:

CₓH_{y}O_{z}+(6x+y−2z)OH′→xCO₃²⁻+(3x+y−z)H₂O+(4x+y−2z)ₑ⁻

The formation of carbonate ions according to the above reaction reduces the ionic conductivity of the electrolyte. This is followed by a deterioration in the performance of the electrochemical generator at a high discharge rate (power performance). By high discharge rate is meant a discharge at a current greater than or equal to Ic Amperes, where Ic is the current necessary to discharge the nominal capacity C of the generator in 1 hour.

An electrochemical generator with an alkaline electrolyte, exhibiting reduced deterioration in performance at a high discharge rate is therefore sought.

The document JP 08-329937 describes the addition of a strontium hydroxide Sr(OH)₂ or strontium carbonate SrCO₃ powder to the positive electrode of an electrochemical generator with an alkaline electrolyte.

The document JP 2003-249222 describes the addition of a compound of strontium oxide SrO or strontium hydroxide Sr(OH)₂ type to the positive electrode of an electrochemical generator with an alkaline electrolyte.

The document EP-A-1006598 describes the use of a deposit of a compound of strontium oxide or hydroxide type on a positive electrode of sintered technology in order to improve the electrode charge properties at high temperature.

The document EP-A-0587974 describes the use of strontium hydroxide powder in the positive electrode or in solid solution in nickel hydroxide in order to increase the oxygen gas evolving overvoltage and to improve the charge properties of the positive electrode.

The document US 2003/129491 proposes the addition of strontium oxide or hydroxide to the positive electrode.

The document U.S. Pat. No. 6,740,449 mentions the use of a nickel hydroxide the surface of which is covered with a layer of strontium hydroxide or the use of a nickel hydroxide containing strontium hydroxide in a solid solution.

The document EP-A-1610403 describes the addition of a strontium or barium compound to an electrochemical generator with an alkaline electrolyte with the exception of the cathode (positive electrode).

The first six documents mentioned above describe the use in the positive electrode, of a strontium compound exclusively in the form of oxide, hydroxide or carbonate. The use of such compounds makes it possible to improve the charge properties of the positive electrode whilst hot. The solutions proposed by the documents previously cited do not make it possible to reduce the deterioration in the discharge performance of the generator at a high discharge rate.

As a result, an electrochemical generator with an alkaline electrolyte, exhibiting a reduced deterioration in discharge performance at a high discharge rate is sought.

### SUMMARY OF THE INVENTION

To this end, the invention proposes an electrochemical generator comprising at least one negative electrode and at least one positive electrode, said positive electrode comprising a paste comprising an electrochemically active material, a binder and strontium sulphate SrSO₄, the proportion by weight of strontium sulphate in said paste being greater than 0.1% and less than or equal to 10%.

According to an embodiment, the proportion of strontium sulphate is greater than or equal to 0.5%.

According to an embodiment, the proportion of strontium sulphate is greater than or equal to 2%.

According to an embodiment, the proportion of strontium sulphate is greater than or equal to 4%.

According to an embodiment, the proportion of strontium sulphate is less than or equal to 8%.

According to an embodiment, the paste contains at least one compound chosen from compounds of zinc, yttrium, ytterbium and calcium.

According to an embodiment, the generator is a generator with an alkaline electrolyte.

According to an embodiment, the generator is of the Nickel-Cadmium type.

According to an embodiment, the generator is of the Nickel-Metal hydride type.

According to an embodiment, the generator is of the Nickel-Zinc type.

The invention also relates to the use of strontium sulphate in the manufacture of a positive electrode of an electrochemical generator in order to reduce the deterioration in the discharge capacity of the generator at a discharge rate greater than or equal to I_{c}.

### DETAILED DESCRIPTION OF EMBODIMENTS OF THE INVENTION

The invention is based on the use of strontium sulphate in the positive electrode. Without wishing to be bound by the theory, the applicant thinks that the addition of strontium sulphate has the effect of eliminating the carbonate ions from the electrolyte, according to the following reaction:

SrSO₄+K₂CO₃→SrCO₃+K₂SO₄

The elimination of the carbonate ions makes it possible to improve the power performance of the generator.

Strontium oxides and hydroxides, the use of which in an electrochemical generator is known from the prior art, are very reactive with the carbon dioxide CO₂ contained in the air. They are therefore converted very rapidly to strontium carbonate, as from the preparation of the electrode. The oxide, hydroxide or carbonate forms are as a result ineffective in eliminating the carbonate ions formed in the electrochemical generator. In order to remedy the problem of the high reactivity of strontium oxides and hydroxides with the carbon dioxide contained in the air, it is necessary to carry out all the stages of the manufacture of the generator under an inert atmosphere. Such a solution leads to significant extra costs in the manufacture of the electrode. The invention makes it possible to eliminate the carbonate ions from the electrolyte and does not require working under a controlled atmosphere.

The method of preparation of the generator according to the invention will now be described in detail. In a conventional manner, a paste is prepared comprising the positive electrochemically active material, a binder, a conductive compound and strontium sulphate SrSO₄, the proportion by weight of strontium sulphate in said paste being greater than 0.1% and less than or equal to 10%.

The paste is obtained by mixing the positive electrochemically active material with the binder, conductive compound, strontium sulphate SrSO₄ and water.

When the proportion by weight of strontium sulphate is less than or equal to 0.1%, it is insufficient to improve the capacity of the electrochemical generator at a high discharge rate.

When the proportion by weight of strontium sulphate is greater than or equal to 10%, the electrical performance is reduced. It is probable that the addition of too large a quantity of strontium sulphate, which is an insulating material, interferes with the electrochemical function of the electrochemically active material.

The positive electrochemically active material can be a nickel-based hydroxide By “nickel-based hydroxide” is meant a nickel hydroxide, a hydroxide containing mainly nickel, but also a nickel hydroxide containing at least one syncrystallized hydroxide of an element chosen from zinc (Zn), cadmium (Cd), magnesium (Mg) and aluminium (Al), and at least one syncrystallized hydroxide of an element chosen from cobalt (Co), manganese (Mn), aluminium (Al), yttrium (Y), calcium (Ca), zirconium (Zr), copper (Cu). A syncrystallized hydroxide contained in the nickel hydroxide is a hydroxide forming a solid solution with nickel hydroxide, i.e. occupying, in continuously variable proportions, the atomic sites defined by the crystal lattice of nickel hydroxide.

The nickel hydroxide can preferably be covered with a coating based on cobalt hydroxide which is optionally partially oxidized, or combined with a conductive compound, mainly constituted by Co(OH)₂. Other compounds such as Co, CoO, LiₓCoO₂, NaₓCoO₂, HₓCoO₂, CoₓO₄, metal powders and carbons can be used as conductive compound.

The binder can be chosen from carboxymethyl cellulose (CMC), hydroxyethyl cellulose (HEC), hydroxypropyl methyl cellulose (HPMC), hydroxypropyl cellulose (HPC), a polyacrylic acid PAAc, a xanthan gum, a styrene and butadiene copolymer (SBR) optionally carboxylated, an acrylonitrile and butadiene copolymer (NBR), a styrene, ethylene, butylene and styrene copolymer (SEBS), a styrene, butadiene and vinylpyridine terpolymer (SBVR), polyamide (PA), a polyethylene (PE), an ethylene-vinyl acetate type copolymer (EVA), a polymer with a polyacrylate type acrylate function, styrene-acrylate, styrene-maleic anhydride, a polytetrafluoroethylene (PTFE), a fluorinated ethylene and propylene copolymer (FEP), polyhexafluoropropylene (PPHF), and perfluoromethylvinylether (PMVE).

According to a preferred embodiment, a mixture of PTFE and CMC is used.

Said paste can moreover contain at least one other compound chosen from compounds of zinc such as ZnO or Zn(OH)₂, of yttrium such as Y₂O₃ or Y(OH)₃, of ytterbium such as Yb₂O₃ or Yb(OH)₃ and of calcium such as CaO, Ca(OH)₂ or CaF₂. This compound is usually added in powder form.

According to an embodiment, conductive or non-conductive fibres can be added to the electrode. Preferably, the quantity of fibres added is less than 1.5%. Preferably, these are polypropylene polymer fibres for example, with a diameter comprised between 10 and 35 μm and less than 2 mm in length.

The paste is deposited on a current-collecting support. The current collector can be a two-dimensional conductive support, such as a solid or perforated strip, an expanded metal, a grid or a woven fabric, or a porous three-dimensional conductive support such as a felt or a foam. This support can be based on metal or carbon. The electrode obtained is of non-sintered type, also called a pasted electrode.

At least one negative electrode is then prepared. An electrochemical bundle is formed by stacking at least one positive electrode according to the invention, a separator and a negative electrode.

The separator is generally composed of polyolefin fibres (e.g. polypropylene) or non-woven porous polyamide.

The electrochemical bundle is inserted into a container. The container is filled with an alkaline electrolyte which is an aqueous alkaline solution which can comprise a mixture of strong bases such as potassium hydroxide KOH, sodium hydroxide NaOH and lithium hydroxide LiOH, in order to constitute the electrochemical generator.

The invention applies to any assembly of electrodes.

The generator can be of button, cylindrical (with a spool or a spiral winding) or prismatic type.

The electrochemical generator according to the invention is preferably an electrochemical generator with an alkaline electrolyte, such as for example the generators containing hydrogen-fixing nickel-metal, nickel-cadmium, nickel-iron, nickel-zinc, nickel-hydrogen pairs.

### EXAMPLES

The reference positive electrode P1, prepared from a damp paste containing 20% water, has the following composition by weight:

| | |
|---|---|
| Nickel foam | 4.00 g/dm² |
| Electrochemically active material | 16.0 g/dm² |
| Conductive material Co(OH)₂ | 1.8 g/dm² |
| PTFE binder | 0.18 g/dm² |
| Cellulose polymer CMC | 0.05 g/dm². |

The powdery electrochemically active material is constituted by a nickel-based hydroxide and contains the following syncrystallized additives: cobalt and zinc. The viscosity of the paste is adjusted with water. The paste is introduced into a three-dimensional conductive support which is a nickel foam with a porosity of approximately 95%. Once the paste is introduced into the support, the mixture is dried in order to eliminate the water from it, rolled then cut in order to obtain the electrode with the desired dimensions. The finished electrode has a porosity of 30% and a grammage of 18 g/dm² of coating material.

The positive electrode P2, prepared from a damp paste containing 20% water, has the following composition by weight:

| | |
|---|---|
| Nickel foam | 5.0 g/dm² |
| Electrochemically active material | 16.0 g/dm² |
| SrSO₄ | 0.02 g/dm² (0.1%) |
| Conductive material Co(OH)₂ | 1.8 g/dm² |
| PTFE binder | 0.18 g/dm² |
| Cellulose polymer CMC | 0.05 g/dm² |

The powdery electrochemically active material is constituted by a nickel-based hydroxide and contains the following syncrystallized additives: cobalt and zinc. The method for the manufacture of the electrode P2 is identical to that of the reference positive electrode P1. The finished electrode has a porosity of 29.9% and a grammage of 18.1 g/dm² of material,

The positive electrode P3, prepared from a damp paste containing 20% water, has the following composition by weight:

| | | |
|---|---|---|
| Nickel foam | 5.00 | g/dm² |
| Electrochemically active material | 16.00 | g/dm² |
| SrSO₄ | 0.4 | g/dm²(2%) |
| Conductive material Co(OH)₂ | 1.8 | g/dm² |
| PTFE binder | 0.2 | g/dm² |
| Cellulose polymer CMC | 0.05 | g/dm² |

The powdery electrochemically active material is constituted by a nickel-based hydroxide and contains the following syncrystallized additives: cobalt and zinc. The method for manufacturing the electrode P3 is identical to that of the reference positive electrode P1. The finished electrode has a porosity of 28.0% and a grammage of 18.4 g/dm² of material.

The positive electrode P4, prepared from a damp paste containing 20% water, has the following composition by weight:

| | | |
|---|---|---|
| Nickel foam | 5.0 | g/dm² |
| Electrochemically active material | 16.0 | g/dm² |
| SrSO₄ | 0.8 | dm² (4%) |
| Conductive material Co(OH)₂ | 1.8 | g/dm² |
| PTFE binder | 0.18 | g/dm² |
| Cellulose polymer CMC | 0.05 | g/dm² |

The powdery electrochemically active material is constituted by a nickel-based hydroxide and contains the following syncrystallized additives: cobalt and zinc. The method for manufacturing the electrode P4 is identical to that of the reference positive electrode P1. The finished electrode has a porosity of 25.8% and a grammage of 18.8 g/dm² of material.

The positive electrode P5 prepared from a damp paste containing 20% water, has the following composition by weight:

| | | |
|---|---|---|
| Nickel foam | 5 | g/dm² |
| Electrochemically active material | 16 | g/dm² |
| SrSO₄ | 2.1 | g/dm²(10%) |
| Conductive material Co(OH)₂ | 1.8 | g/dm² |
| PTFE binder | 0.18 | g/dm² |
| Cellulose polymer CMC | 0.05 | g/dm² |

The powdery electrochemically active material is constituted by a nickel-based hydroxide and contains the following syncrystallized additives: cobalt and zinc. The method for manufacturing the electrode P5 is identical to that of the reference positive electrode P1. The finished electrode has a porosity of 19.5% and a grammage of 20.1 g/dm² of material.

The positive electrode P6 prepared from a damp paste containing 20% water, has the following composition by weight:

| | | |
|---|---|---|
| Nickel foam | 5.0 | g/dm² |
| Electrochemically active material | 16.0 | g/dm² |
| Sr(OH)₂ | 8 | g/dm²(4%) |
| Conductive material Co(OH)₂ | 1.8 | g/dm² |
| PTFE binder | 0.18 | g/dm² |
| Cellulose polymer CMC | 0.05 | g/dm² |

The powdery electrochemically active material is constituted by a nickel-based hydroxide and contains the following syncrystallized additives: cobalt and zinc. The method for manufacturing the electrode is identical to that of the reference positive electrode P1. The finished electrode has a porosity of 25.8% and a grammage of 18.8 g/dm² of material.

The reference negative electrode N1 is produced with a paste having as its composition by weight (expressed in % relative to the weight of the paste):

| | |
|---|---|
| Electrochemically active material | 80.0% |
| Binder: SBR | 0.5% |
| Carbon | 0.3% |
| Thickener | 0.2% |
| Water: | 19.0% |

The electrochemically active material is an intermetallic compound capable of forming a hydride once charged. The viscosity of the paste is adjusted with water. The paste is introduced into the conductive support which is a nickel foam. The mixture is then dried in order to eliminate the water from it, then rolled at a porosity of 25% in order to obtain the electrode. The capacity of the negative electrode is greater than that of the positive electrode.

The negative electrode N2 is produced with a paste having as its composition by weight (expressed in % relative to the weight of the paste):

| | |
|---|---|
| Electrochemically active material | 80.0% |
| SrSO₄ | 3.8% |
| Binder: SBR | 0.5% |
| Carbon | 0.3% |
| Thickener | 0.2% |
| Water: | 19.0% |

The electrochemically active material is an intermetallic compound capable of forming a hydride once charged. The viscosity of the paste is adjusted with water. The paste is introduced into the conductive support which is a nickel foam. The mixture is then dried in order to eliminate the water from it, then rolled at a porosity of 25% in order to obtain the electrode. The capacity of the negative electrode is greater than that of the positive electrode.

An NiMH sealed secondary electrochemical generator of format AA the nominal capacity C of which is 1200 mAh is constituted by a positive electrode and a negative electrode described above. The electrodes are separated by a non-woven polypropylene separator in order to form the electrochemical bundle. The thus wound bundle is inserted into a metal cup (or container) and impregnated with an alkaline electrolyte which is an aqueous alkaline solution constituted by a mixture of potassium hydroxide KOH 7.5N, sodium hydroxide NaOH 0.4N and lithium hydroxide LiOH 0.5N in order to constitute the generator.

TABLE 1

| | Positive | |
|---|---|---|
| Series | electrode | Negative electrode |
| A | P1 | N1 |
| B | P2 | N1 |
| C | P3 | N1 |
| D | P4 | N1 |
| E | P5 | N1 |
| F | P6 | N1 |
| G | P1 | N2 |

### Electrochemical Performances

After resting for 48 hours at ambient temperature, the generators then undergo about a dozen slow cycles.

Cycle 1:
Charge at 0.025 Ic for 3 hours, where Ic is the current necessary to discharge the nominal capacity C of the generator in 1 hour,
Charge for 3 hours at 0.33 Ic,
Discharge at 0.2 Ic up to a voltage of 1V.

Cycles 2 to 10:
Charge for 16 hours at 0.1 Ic,
Discharge at 0.2 Ic up to a voltage of 1V.

Cycle 11:
Charge for 72 minutes at Ic,
Discharge at Ic up to a voltage of 1V.

Cycle 12:
Charge for 72 minutes at Ic,
Discharge to 3 Ic up to a voltage of 1V,

Cycle 13:
Charge for 72 minutes at Ic,
Discharge at 5 Ic up to a voltage of 1V.

TABLE 2

| Series | A | B | C | D | E | F | G |
|---|---|---|---|---|---|---|---|
| Capacity | 1251 | 1256 | 1252 | 1248 | 1247 | 1246 | 1253 |
| discharged in | | | | | | | |
| cycle 10 | | | | | | | |
| (mAh) | | | | | | | |
| Capacity | 1201 | 1206 | 1214 | 1223 | 1216 | 1197 | 1203 |
| discharged at Ic | | | | | | | |
| in cycle 11 | | | | | | | |
| (mAh) | | | | | | | |
| Capacity | 1063 | 1068 | 1139 | 1173 | 1153 | 1072 | 1065 |
| discharged at 3Ic | | | | | | | |
| in cycle 12 | | | | | | | |
| (mAh) | | | | | | | |
| Capacity | 875 | 892 | 1027 | 1123 | 1085 | 898 | 889 |
| discharged at 5Ic | | | | | | | |
| in cycle 12 | | | | | | | |
| (mAh) | | | | | | | |

The generators C, D and E, the positive electrode of which contains more than 0.1% strontium sulphate, have a discharge capacity at a rate of 5Ic of at least 1027 mAh, whereas the generators A and B, the positive electrode of which contains a proportion by weight of strontium sulphate less than or equal to 0.1%, have a discharge capacity at the same rate of only 875 and 892 mAh respectively. It is understood from these results that the addition of a quantity of strontium sulphate in a proportion by weight greater than 0.1% makes it possible to significantly improve the generator's capacity at a high discharge rate. The addition of a quantity of strontium sulphate greater than 10% interferes with the electrochemical function of the nickel hydroxide. In fact, strontium sulphate is an insulating material.

On the other hand, series F shows that the addition of strontium hydroxide to the positive electrode does not make it possible to improve the power performance, the compound probably already being totally converted to strontium carbonate before the filling of the generator.

Finally, series G shows that the addition of strontium sulphate to the negative electrode is not effective in improving the power of the generator. The elimination of the carbonates is in fact more difficult in this case due to the distance of the strontium sulphate from the source of carbonates originating from the positive electrode.

1. Electrochemical generator comprising at least one negative electrode and at least one positive electrode, said positive electrode comprising a paste comprising an electrochemically active material, a binder and strontium sulphate SrSO₄, the proportion by weight of strontium sulphate in said paste being greater than 0.1% and less than or equal to 10%.

2. Generator according to claim 1, in which the proportion of strontium sulphate is greater than or equal to 0.5%.

3. Generator according to claim 1, in which the proportion of strontium sulphate is greater than or equal to 2%.

4. Generator according to claim 1, in which the proportion of strontium sulphate is greater than or equal to 4%.

5. Generator according to claim 1, in which the proportion of strontium sulphate is less than or equal to 8%.

6. Generator according to claim 1, in which the paste contains at least one compound chosen from the compounds of zinc, yttrium, ytterbium and calcium.

7. Generator according to claim 1, which is a generator with an alkaline electrolyte.

8. Generator according to claim 7, of the Nickel-Cadmium type.

9. Generator according to claim 7, of the Nickel-Metal hydride type.

10. Generator according to claim 7, of the Nickel-Zinc type.

11. Use of strontium sulphate in the manufacture of a positive electrode of an electrochemical generator in order to reduce the deterioration in the discharge capacity of the generator at a discharge rate greater than or equal to I_{c}
